(19) United States
(12) Patent Application Publication
(10) Pub. No.: US 2008/0177435 A1
(43) Pub. Date: Jul. 24, 2008

(54) INTELLIGENT TOW BAR

(75) Inventors: Michael E. Caporali, Owego, NY (US); Michael A. Wisniewski, Owego, NY (US)

Correspondence Address: BURNS & LEVINSON, LLP, 125 SUMMER STREET, BOSTON, MA, 02110, US

(73) Assignee: Lockheed Martin Corporation, Bethesda, MD (US)

(21) Appl. No.: 12/058,214

(22) Filed: Mar. 28, 2008

Related U.S. Application Data
(62) Division of application No. 11/341,031, filed on Jan. 27, 2006.

(51) Int. Cl. G05D 27/02

(52) U.S. Cl. 701/23

(57) ABSTRACT

A tow bar for connecting and controlling two autonomous vehicles with respect to one another. The tow bar including a plurality of sections with at least one sensors mounted or coupled onto each, for measuring and determining the orientation of one autonomous vehicle in relation to the other autonomous vehicle. A signal may be transmitted to either or to both of the autonomous vehicles to control propulsion and/or steering and/or braking of the vehicles when an adjustment is required to maintain stability of the tandem vehicles.

### BACKGROUND OF THE INVENTION

This invention relates to the towing of one autonomous vehicle by another autonomous vehicle, and, more particularly, to a tow bar connected between the vehicles and providing information as to vehicle orientation and traction to a controller of vehicle operation.

Towing needs are present in a variety of situations. A tractor may pull a trailer along a highway, may pull a farm implement such as a sprayer between crop rows, or may pull an aircraft into a hangar. A common aspect of the above situations is that the terrain is generally level and the vehicle under tow is unpowered. The trailer or towed vehicle may have independent steering and braking ability, but generally lacks independent propulsion.

Other environments where towing is required are less accommodating. For example, the terrain may be off road and include slopes of hills and mountains. Within a short distance, traction may change from firm to absent as the traction available to individual vehicle wheels is reduced as a result of contact with loose rocks, mud, ice, snow, or wet pavement. There is the ever present danger of a trailer slipping out of control and endangering both vehicles.

Further, current tow bars do not provide control signals for control of propulsion, braking, and steering to the vehicles based on information provided by the tow bar. Currently, in towing situations, most tow bars are passive in nature. Some have been designed to allow for a fairly simple braking control of the towed vehicle. In some instances separate brake control units are available to allow for brake application in the towed vehicle. By themselves, independent steering and braking for the tractor and the trailer may not be able to preserve a tandem arrangement of the vehicles where the towed vehicle follows directly behind the towing vehicle.

### BRIEF SUMMARY OF THE INVENTION

The needs for the present invention set forth above as well as further and other needs and advantages of the present invention are achieved by the embodiments of the invention described herein below.

According to one aspect of the invention, a tow bar for connecting a first autonomous vehicle to a second autonomous vehicle in a tandem arrangement includes several sections—a first section coupled to the first autonomous vehicle and to a strain module, a second section coupled to the strain module and to a roll sensor, a third section coupled to the roll sensor and to a first angular sensor, a fourth section coupled to the first angular sensor and to a second angular sensor, and a terminal section coupled to the second angular sensor and to the second autonomous vehicle. In other embodiments of the invention, the terminal section comprises a fifth section coupled to the second angular sensor and to a sixth section and to a seventh section, and the sixth section and the seventh sections coupled to the fifth section and to the second autonomous vehicle. The exact number of sections may vary within the scope of the present invention.

In certain embodiments of the invention, the roll sensor may detect a roll angle between the first and second sections, the first angular sensor a pitch angle between the third and the fourth sections, and the second angular sensor a yaw angle between the fourth and the terminal sections. In other embodiments, the sixth and the seventh sections may be adjustable in length where each may include a plurality of subsections held in position by biasing mechanisms, which may be spring pins.

According to another aspect of the invention, a method for maintaining a tandem arrangement of a first autonomous vehicle and a second autonomous vehicle includes measuring at least one angle characterizing an orientation of the first autonomous vehicle relative to the second autonomous vehicle, measuring a force between the first and second autonomous vehicles, and determining acceleration, braking, and steering of the second autonomous vehicle on the basis of the measured angle and force, and effecting the acceleration, braking, and steering to maintain the tandem arrangement.

In other embodiments, the measured angle may be a roll angle and may be measured with a roll sensor, may be a pitch angle and may be measured with an angular motion sensor, or may be a yaw angle and may be measured with an angular motion sensor. In another embodiment, the method may include transmitting the measured angle to a controller. In a further embodiment, the force between the first and second autonomous vehicles may be measured with a strain module. In a still further embodiment, the method may include transmitting the measured force. In a certain embodiment, the method may also include determining likelihood of a roll over of the tandem arrangement.

According to a further aspect of the invention, a system for maintaining a tandem arrangement of a first autonomous vehicle and a second autonomous vehicle includes means for measuring at least one angle characterizing an orientation of the first autonomous vehicle relative to the second autonomous vehicle, means for measuring a force between the first and second autonomous vehicles, means for determining an acceleration, braking, and steering of the second autonomous vehicle on the basis of the at least one measured angle and measured force, and means for effecting the acceleration, braking, and steering of the second autonomous vehicle to maintain the tandem arrangement.

In one embodiment of the invention, the system includes means for transmitting the measured angle. In another embodiment, the system may include means for transmitting the measured force.

According to a further aspect of the invention, a multi-vehicle control system includes a first vehicle, a second vehicle, and a tow bar. The tow bar interconnects the first vehicle with the second vehicle and includes a plurality of sections and at least one sensor. The sensor is coupled to at least one of the sections and is capable of measuring an orientation of the first vehicle in relation to the second vehicle.

In another embodiment of the invention, the tow bar includes a first section coupled to the first autonomous vehicle and to a strain module, a second section coupled to the strain module and to a roll sensor, a third section coupled to the roll sensor and to a first angular sensor, a fourth section coupled to the first angular sensor and to a second angular sensor, and a terminal section coupled to the second angular sensor and to the second autonomous vehicle.

In a further embodiment of the invention, the terminal section comprises a fifth section coupled to the second angular sensor and to a sixth section and to a seventh section, and the sixth section and the seventh sections coupled to the fifth section and to the second autonomous vehicle.

For a better understanding of the present invention, together with other and further needs thereof, reference is made to the accompanying drawings and detailed description. Its scope will be pointed out in the appended claims.

### BRIEF DESCRIPTION OF THE SEVERAL VIEWS OF THE DRAWINGS

FIG. 1 is a schematic of a tractor-trailer combination pulling a second nonautonomous trailer mounted on a prior art nonautonomous steerable dolly;

FIG. 2 is a pictorial of an embodiment of the present invention where the tow bar of this invention connects an autonomous utility vehicle with an autonomous companion trailer;

FIG. 3A is a pictorial of the tow bar embodiment of the present invention shown in FIG. 2 illustrating the various interconnected sections;

FIG. 3B is a pictorial of FIG. 3A illustrating the interconnection of two leg sections by a spring pin;

FIG. 3C is a pictorial of another tow bar embodiment of the present invention including a terminal section.

FIG. 4A is a pictorial of the tow bar embodiment of the present invention shown in FIGS. 2. 3A, and 3B illustrating various sensors mounted to the interconnected sections;

FIG. 4B is a schematic block diagram illustration of the UV controller and the control loop of the present invention;

FIG. 5 is a pictorial representing several angles that characterize the orientation of the autonomous companion trailer with respect to that of the autonomous utility vehicle;

FIG. 6 is a process flow diagram illustrating one logical method for correcting the orientation of one autonomous vehicle relative to another autonomous vehicle in the present invention;

FIG. 7 is a process flow diagram of a closed loop control circuit for preserving the tandem arrangement of a first and a second autonomous vehicle in the present invention; and

FIG. 8 is a pictorial of an embodiment of the present invention illustrating orientation sensors attached to the tow bar.

### DETAILED DESCRIPTION OF THE INVENTION

Independent propulsion, in addition to independent braking and steering, on a pulled vehicle, such as a trailer, is characteristic of an autonomous vehicle and allows for control of a tandem arrangement of a pulling vehicle, such as a tractor, and the trailer that is absent when only the tractor has propulsion and, consequently, is autonomous. However, preservation of the tandem arrangement of the two vehicles depends upon knowledge of the traction condition of both vehicles and the orientation of one vehicle with respect to the other. On the basis of traction and orientation information of the vehicles, propulsion, steering, and braking of one or both vehicles may be adjusted to achieve a stable tandem arrangement where the trailer follows directly behind and in line with the tractor.

There are reasons for providing trailers with independent propulsion. For example, transport vehicles may be more easily loaded onto and unloaded from airplanes or ships if they have their own means of movement and do not have to rely on an independent tractor or sheer manpower. Further, efficiency is enhanced if several transport vehicle are attached so that only a single driver is needed. Coincidentally, because of the nature of certain missions, transport vehicles are likely to encounter the variability of terrain that tends to disrupt a tandem relationship.

Control of an independently powered tandem arrangement of a tractor and a trailer depends upon acquisition and transmission of accurate orientation and traction information to a controller for processing into steering, braking, and acceleration instructions to the tractor and trailer. This information may be acquired by means independent of the tractor and trailer since such means are necessary only when the tractor and trailer are attached and not when they are separated. An intelligent tow bar, as further described below, may provide such orientation information.

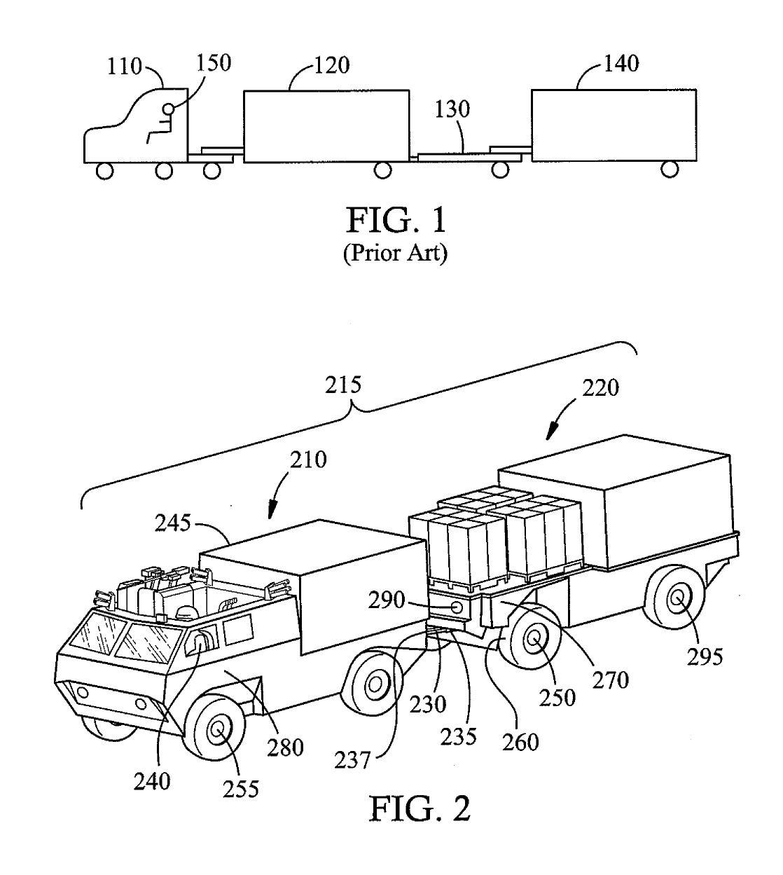

FIG. 1 illustrates a typical tandem tractor/trailer arrangement in operation today. A tractor 110 pulls a nonautonomous trailer 120, which is pulling a dolly 130, which itself is pulling a second nonautonomous trailer 140. The dolly 130 may have its own steering and braking capabilities that can be employed by a driver 150 of the tractor 110 to supplement the actions of the tractor 110, for example, braking the dolly 130 when the tractor 110 is braked or steering the dolly 130 in the direction in which the tractor 110 is steered. However, if the second trailer 140 begins to fall out of alignment, that is, to jackknife or to tip, the second trailer 140 and the dolly 130 can do little to correct the difficulty. There is no facility to sense the actions of the second nonautonomous trailer 140 or to use a separate propulsion system to avoid or circumvent a difficult situation.

FIG. 2 illustrates one embodiment of the tow bar 230 of the present invention connecting or coupling an autonomous tractor or utility vehicle (UV) 210 to an autonomous trailer or companion trailer (CT) 220. In this case, the CT 220 is essentially a cab-less truck capable of both autonomous operation and being towed behind the UV 210. The CT 210 may contain the same propulsion system and drive components as the UV 210 or different ones.

For towing the CT 220 with the UV 210, there will be instances when the CT 220 should be under active control of the UV 210 to insure that the UV/CT tandem 215 stays in control and does not endanger vehicle driver 240 or equipment 245. The UV 220 needs to control the CT brakes 250, steering 260, propulsion 270 (diesel, electric, diesel/electric hybrid or any other drive system), and other subsystems, such as lights 290 and parking brakes 295. Closed loop control feedback to the UV controller 280 based upon monitoring of CT operation, allows correction of control problems and allows alert to the UV driver 240 of potential problems. Given the mission profile, such as resupply necessitating a large payload divided between the UV and the CT, lack of CT control could lead to overall UV/CT 215 tandem control concerns, such as sliding down a steep grade, tipping over, jack knifing, or otherwise causing instability of the tandem arrangement.

In certain instances, control of the CT 220 may simply follow commands of the UV driver 240 to the UV 210. For example, when the driver 240 in the UV 210 engages the UV brake 255, or alternatively commands acceleration, the CT 220 will be directed to brake, or to accelerate, as well. However, if the CT 220 is in a different situation than is the UV 210, the CT 220 may respond to the commands in a manner that differs from the response of the UV 210 to those commands. For instance, if the CT 220 has better, or worse, traction than does the UV 210, the CT 220 may hinder UV/CT tandem 215 operation and may place the driver 240 and/or the equipment 245 in jeopardy. Therefore, the UV controller 280 needs to be aware of CT 220 conditions.

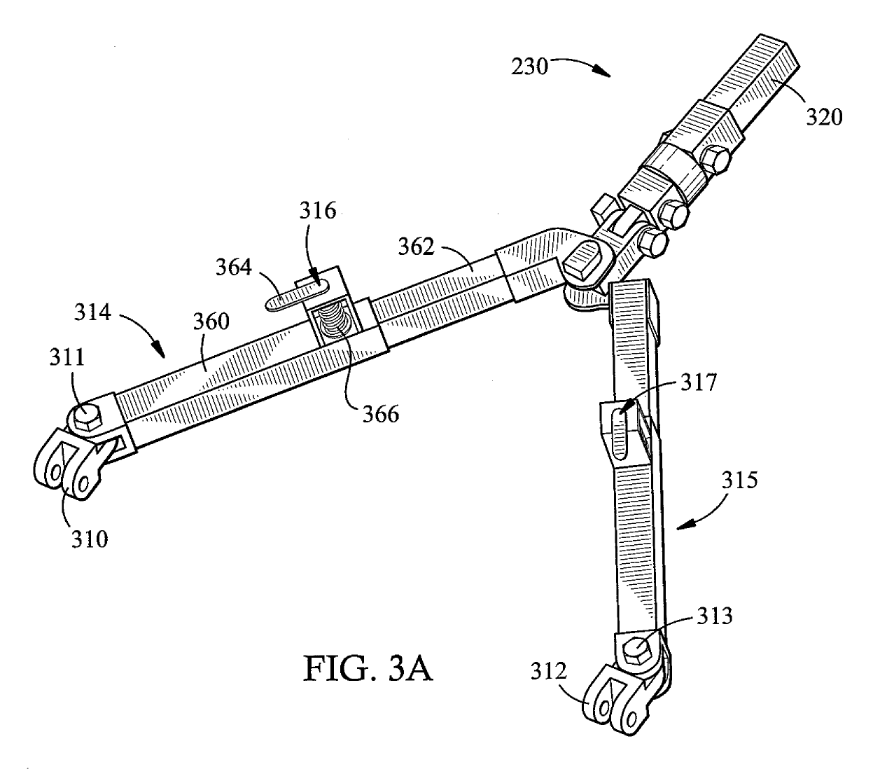

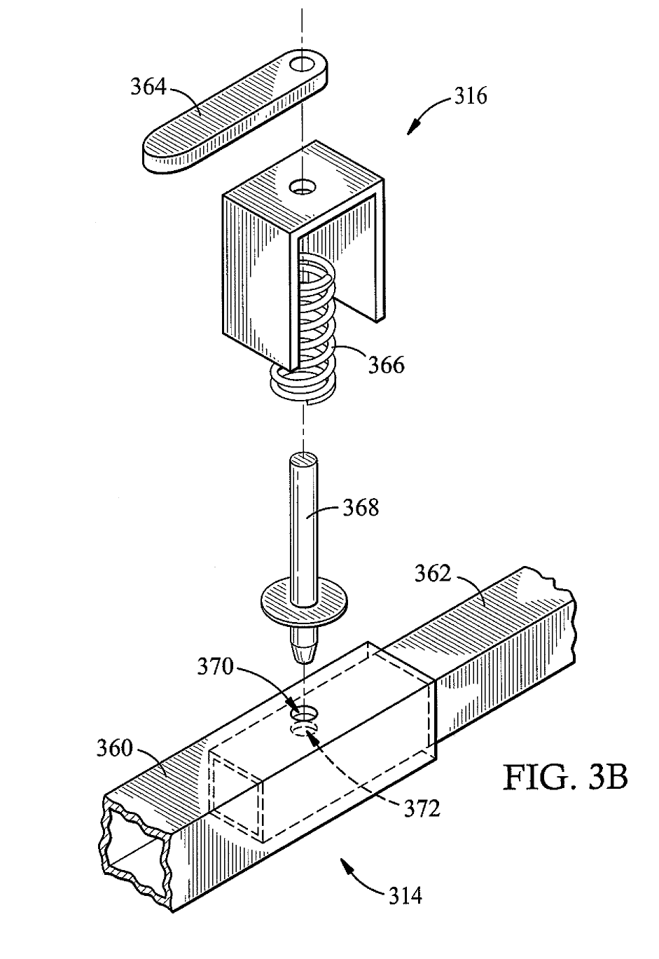

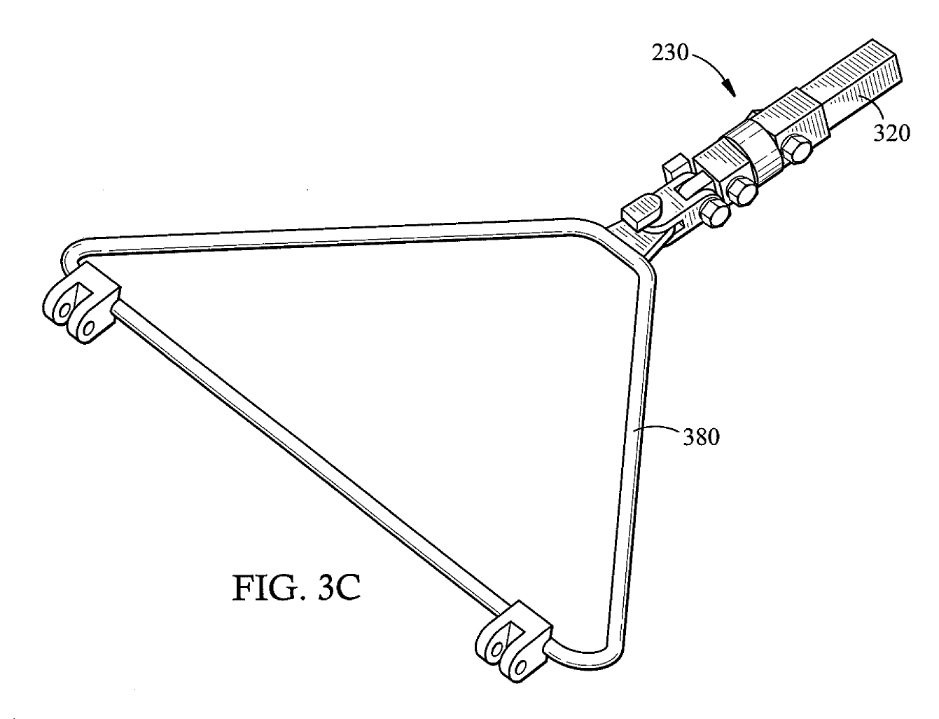

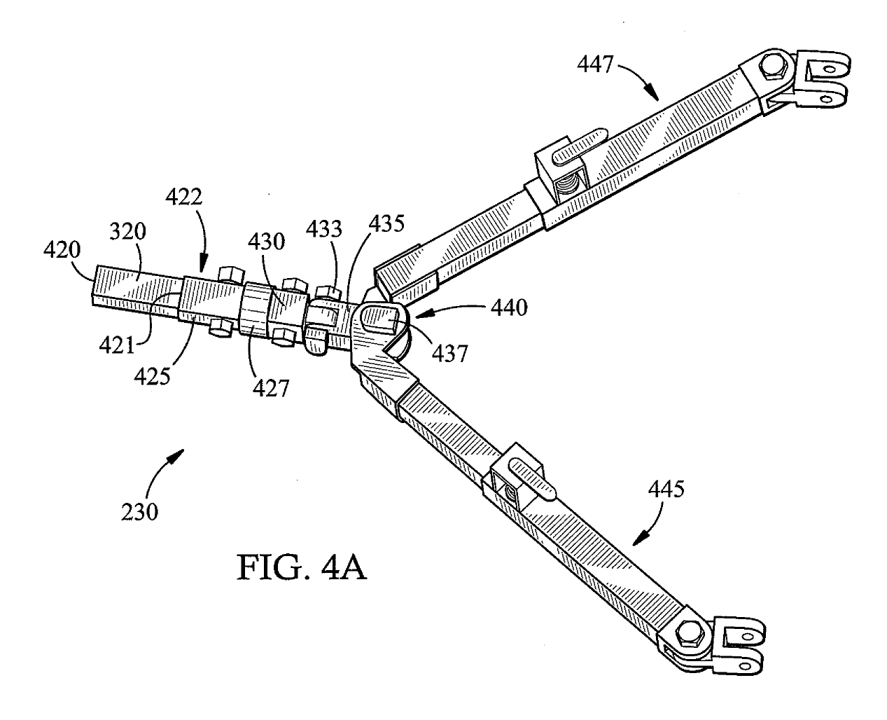

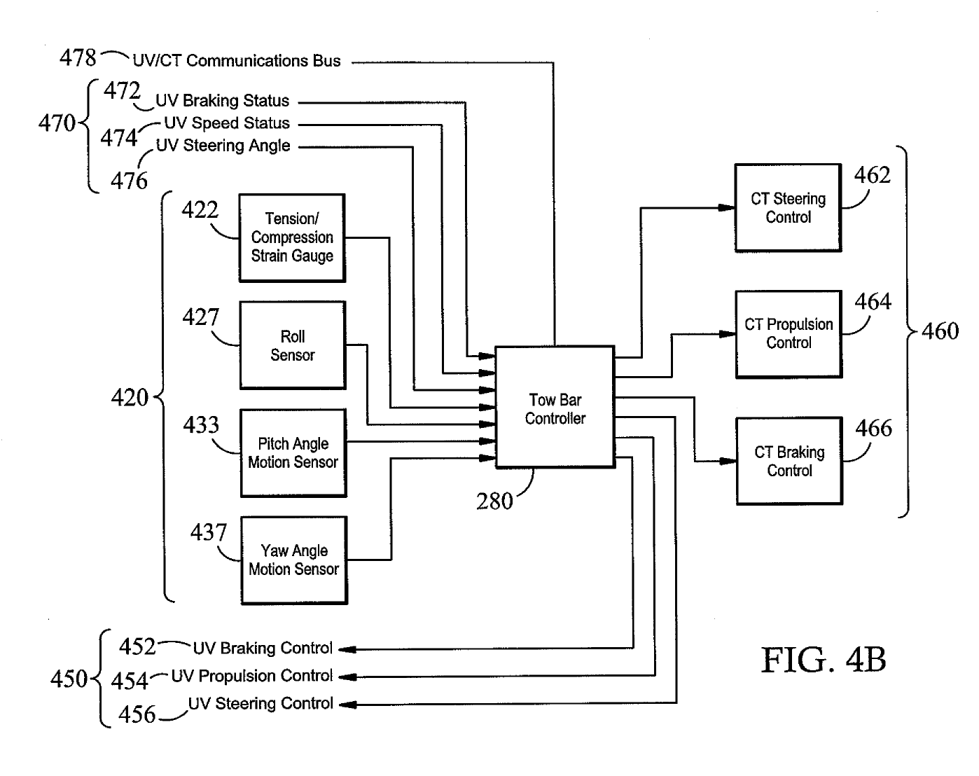

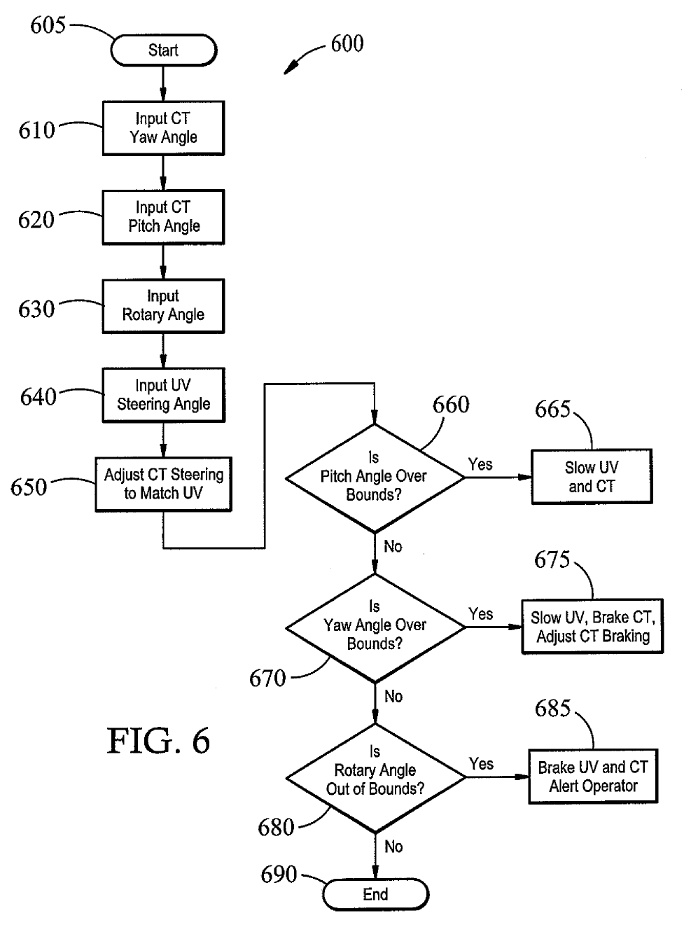

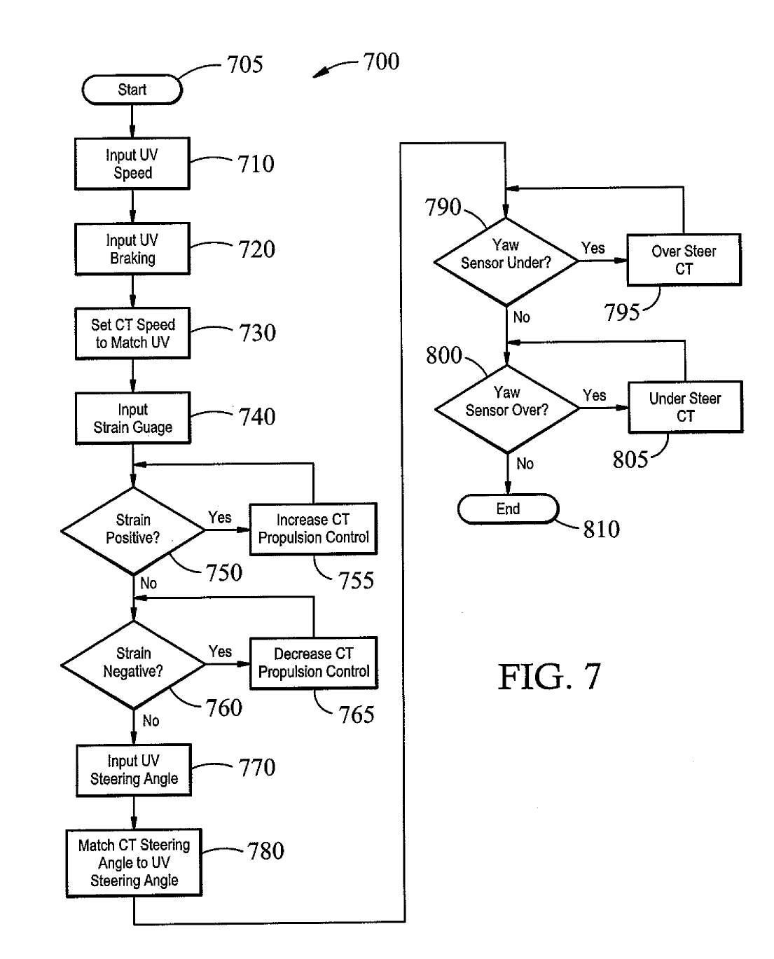

FIG. 3A illustrates an embodiment of the tow bar 230 for providing situational awareness of the CT 220 to the UV 210 and to the UV controller 280, leading to closed loop control via positive control feedback to the UV controller 280. (A block diagram of a closed loop control circuit including UV controller 280 is provided in FIG. 4B and process flow diagrams illustrative of two methods of control are provided in FIGS. 6 and 7.) In providing CT operational status data to the UV 210 or UV controller 280, the tow bar 230 can inform the UV 210 or UV controller 280 if the CT 220 is tending to drag, or push, relative to the UV 210. The tow bar 230 can also monitor whether the CT 220 is maintaining a proper following orientation, and not, for example, slipping on a scree- or small rock-covered side slope traverse.

As illustrated in FIGS. 2, 3A, and 3B, the tow bar 230 forms a fixed length three-point connection between the CT 220 and UV 210. The tow bar 230 uses links 310 and 312 to attach to forward tow provisions 235 on the CT 220 and the receiver mount neck 320 to the towing receiver 237 on the UV 210. Built in pivots 311 and 313 allow the desired variation in UV/CT vehicle alignment when hooking up. Additionally, leg 314 and leg 315 of the tow bar 230 have biasing mechanisms, shown as spring pin 316 and spring pin 317 respectively, that allows the lengths of leg 314 and leg 315 to vary during hook up. Then, pin 368 passes through a hole 370 in a first section 360 of leg 314 and rides on top of a second section 362 of leg 314. Once linked, the driver 240 simply drives forward or backward so as to cause the pin 368 to engage in a hole 372 of the second section 362, thereby fixing the length of leg 314. Similarly, the length of the leg 315 is fixed. As a result, the leg 314 and the leg 315 form a fixed length connection with the receiver mount neck 320.

FIG. 3C illustrates another embodiment of the invention where a terminal section 380 enables the tow bar 230 to form a fixed length connection between the CT 220 and the forward tow provisions 235 on the CT 220. In this embodiment, the length of the tow bar 230 is not adjustable, as was the case in the embodiment illustrated in FIGS. 3A and 3B.

As shown in FIG. 4A, the tow bar 230 includes a plurality of sensors to measure the orientation of the CT 220 relative to the UV 210 and the pulling or pushing force exerted by the CT 220 on the UV 210. This data input is employed by the UV controller 280, shown schematically in FIG. 4B, to direct the CT 220 to execute steps to insure that the CT 220 follows properly behind the UV 210.

Where the UV 210 simply tows the CT 220 over fairly even improved roads, the tow bar 230 may act as a conventional tow bar and simply pull the CT 220. However, most towing of the CT 220 by the UV 210 occurs off-road on un-improved roads. Given the requirements of grade climb/descend and traverse, a significant amount of control of the CT 220 will be required to prevent accidents like roll-overs. The intelligent tow bar 230 may provide one source of information to allow the CT 220 to be accelerated, braked, or steered in order to maintain control. This also allows for “torque blending” of UV 210 and the CT 220 vehicles to optimize performance in off road driving. The requisite amount of power to move the tandem arrangement 215 is divided between the UV 210 and the CT 220, not overly taxing either vehicle and taking advantage of the vehicle and wheels having the most traction.

As illustrated in FIG. 4A, first section, receiver mount neck, 320, couples to the UV 210 at a first end 420 and to a second section 425 at a second end 421 via a tension/compression strain module 422. The second section 425 couples to a third section 430 via a roll sensor 427, which may be a rotary encoder. The third section 430 pivotally couples to a fourth section 435 via a first angular motion sensor 433. The fourth section 435 couples to a fifth section 440 via a second angular motion sensor 437. The fifth section 440 also couples to a sixth section 445 or leg 314 and seventh section 447 or leg 315. In the embodiment of FIG. 3C, the terminal section 380 plays the role of the fifth 440, sixth 445, and seventh 447 sections in coupling between the second angular motion sensor 437 and the CT 220.

Transmission of the status of the tension/compression strain module 422, together with the status of the roll sensor 427 and first 433 and second 437 angular motion sensors to UV controller 280 provides the UV controller 280 with the extent to which the UV 210 pulls or is pulled by the CT 220 and the relative orientations of the CT 220 with respect to the UV 210.

As illustrated in FIG. 4B for control loop 400, the UV controller 280 receives UV status indicators 470 over a UV/CT communications bus 478. UV status indicators 470 may include a UV braking status 472, a UV speed status 474, and a UV steering angle 476. The UV controller 280 also receives tow bar orientation status indicators 420 from the tow bar 230. The tow bar orientation status indicators 420 include signals from the tension/compression strain gauge or module 422, the roll sensor 427, and the first 433 and the second 437 angular motion sensors. The first angular motion sensor 433 includes a pitch angle motion sensor and the second angular motion sensor 437 includes a yaw angle motion sensor.

On the basis of the UV status 470 and tow bar orientation status 420 indicators, the UV controller 280 provides UV control signals 450 and CT control signals 460. The UV control signals 450 may include a UV braking control 452, a UV propulsion control 454, and a UV steering control 456. The CT control signals 460 may include a CT steering control 462, a CT propulsion control 464, and a CT braking control 466.

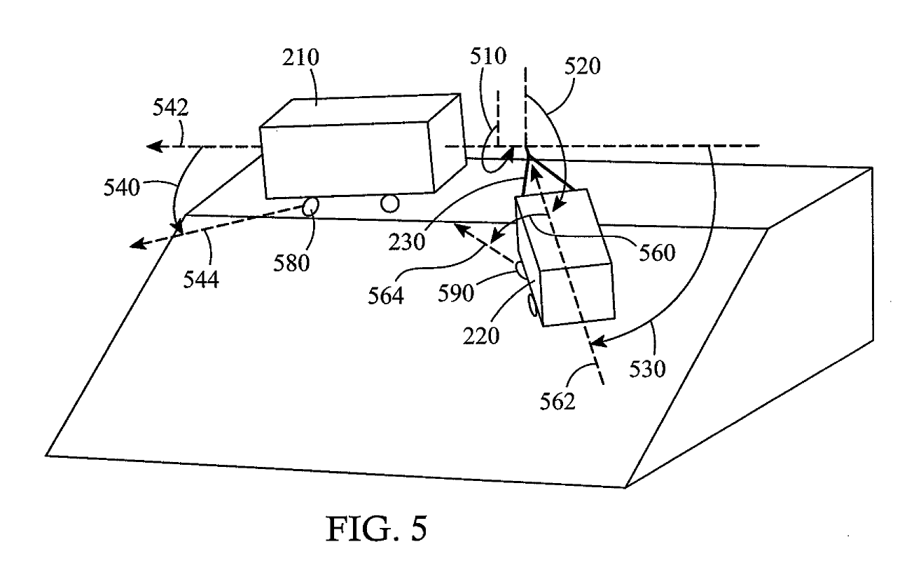

FIG. 5 illustrates the association of the angles with the relative orientation. Roll sensor 427 provides a measure of a roll angle 510 of the CT 220 relative to the UV 210, first angular motion sensor 433 of a pitch angle 520 of the CT 220 relative to the UV 210, and second angular motion sensor 437 of a yaw angle 530 of the CT 220 relative to the UV 210. UV steering angle 540 is the angle between the direction 544 in which UV steering wheels 580 are pointing and the direction 542 in which the UV 210 is pointing. CT steering angle 560 is the angle between the direction 564 in which CT steering wheels 590 are pointing and the direction 562 in which the CT 220 is pointing.

With the distance between towing provisions fixed along with the length of tow bar legs 314 and 315, sensors provide measures of angular differences, rotational differences, and tension/compression in the tow bar 230. This sensory input then forms one source for control information for closed loop control of the CT 220 by the UV 210, as shown in the process flow diagrams of FIGS. 6 and 7.

FIG. 6 provides a process flow diagram 600 illustrating one logical method for correction of the orientation of the CT 220 vehicle relative to the UV 210. Upon input of the CT yaw angle 530 in step 610, the CT pitch angle 520 in step 620, the roll or rotary angle 510 in step 630, and the UV steering angle 540 in step 640, the CT steering angle 560 is adjusted to match the UV steering angle in step 650. The pitch angle 520, the yaw angle 530, and the rotary angle 510 are then assessed in steps 660, 670, and 680, respectively, to determine whether any are out of bounds. If the pitch angle 520 is out of bounds, the UV 210 and the CT 220 are slowed in step 665. If the yaw angle 530 is out of bounds, the UV 510 is slowed, the CT 220 is braked, and the steering of the CT 220 is adjusted in step 675. If the rotary angle 510 is out of bounds, the UV 220 and the CT 210 are braked and the operator or driver 240 is alerted in step 685.

FIG. 7 provides a process flow diagram 700 of a closed loop control circuit for preserving the tandem arrangement of the UV 210 and the CT 220. Following input of the speed of the UV 210 in step 710 and the speed of the CT 220 in step 720, the speed of the CT 220 is set to match the speed of the UV 210 in step 730. Following input of a signal from the strain gauge 422 in step 740, if the strain is found to be positive in step 750, propulsion of the CT 220 is increased in step 755. If the strain is found to be negative in step 760, propulsion of the CT 220 is decreased in step 765. Following input of the UV steering angle 540 in step 770, the CT steering angle 560 is matched to the UV steering angle 540 in step 780. If the yaw sensor 437 indicates an under value in step 790, the CT 220 is oversteered in step 795. If the yaw sensor 437 indicates an over value in step 800, the CT 220 is understeered in step 805.

In some instances of towing, such as on improved roads over even terrain it may not be necessary to have this tight control. For reasons of fuel conservation it may be desirable to not run the CT propulsion system. However it may still be necessary to control steering, and it will always be necessary to control brakes. The intelligent tow bar 230 may provide input in any case if desired.

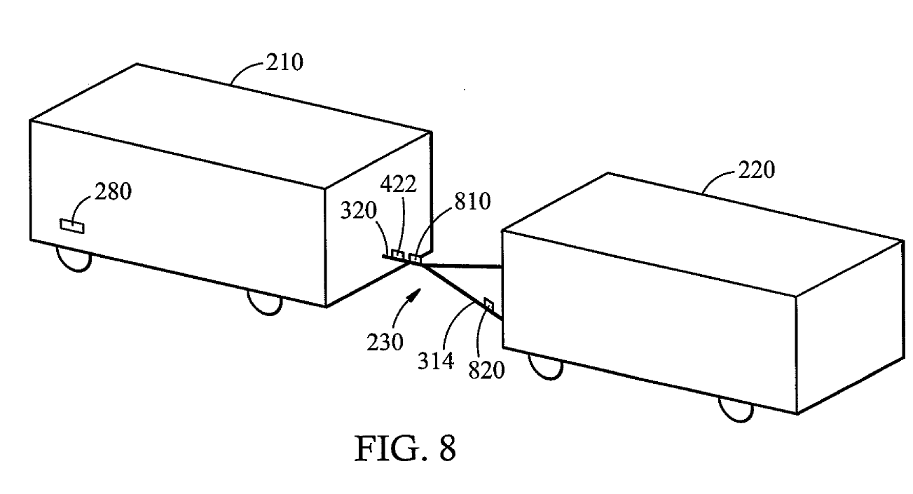

FIG. 8 illustrates another embodiment of the present invention where a first orientation sensor 810 may be attached to the receiver mount neck 320, fixed with respect to the UV 210, and a second orientation sensor 820 attached to the leg 314, fixed with respect to the CT 220. The first orientation sensor 810 and the second orientation sensor 820 may transmit a first and a second output to the UV controller 280 by wire or wireless connection (as shown in FIG. 8). Based at least in part on the outputs of the first orientation sensor 810 and the second orientation sensor 820 outputs, the UV controller 280 may determine the orientation of the CT 220 relative to the UV 210, and, in conjunction with the output provided by the tension/compression strain module 422 mounted on the tow bar 230, may determine a UV propulsion, braking, and steering and a CT propulsion, braking, and steering that, upon implementation by the UV 210 and the CT 220, restores and preserves the inline tandem relationship between the UV 210 and the CT 220. The first orientation sensor 810 and the second orientation sensor 820 may include gyroscopes that may further include angular rate sensors, accelerometers, and magnetometers in combination with transmitters.

Although the invention has been described with respect to various embodiments, it should be realized that this invention is also capable of a wide variety of further and other embodiments within the spirit and the scope of the appended claims.

1-10. (canceled)

11. A method for maintaining a tandem arrangement of a first autonomous vehicle and a second autonomous vehicle, the method comprising:
measuring at least one angle, the at least one angle characterizing an orientation of the first autonomous vehicle relative to the second autonomous vehicle;
measuring a force between the first autonomous vehicle and the second autonomous vehicle;
determining a propulsion, a braking, and a steering of the second autonomous vehicle on the basis of the at least one measured angle and the measured force, the propulsion, the braking, and the steering consistent with maintenance of the tandem arrangement; and
effecting the propulsion, the braking, and the steering of the second autonomous vehicle so as to maintain the tandem arrangement of the first autonomous vehicle and the second autonomous vehicle.

12. The method of claim 11, wherein measuring said at least one angle between the first autonomous vehicle and the second autonomous vehicle includes measuring a roll angle.

13. The method of claim 12, wherein measuring said roll angle includes measuring with a roll sensor.

14. The method of claim 11, wherein measuring said at least one angle between the first autonomous vehicle and the second autonomous vehicle includes measuring a pitch angle.

15. The method of claim 14, wherein measuring said pitch angle includes measuring with an angular motion sensor.

16. The method of claim 11, wherein measuring said at least one angle between said first autonomous vehicle and said second autonomous vehicle includes measuring a yaw angle.

17. The method of claim 16, wherein measuring said yaw angle includes measuring with an angular motion sensor.

18. The method of claim 11, further including transmitting said at least one measured angle.

19. The method of claim 11, wherein measuring said force between the first autonomous vehicle and the second autonomous vehicle includes measuring with a strain module.

20. The method of claim 11, further including transmitting said measured force between the first autonomous vehicle and the second autonomous vehicle.

21. The method of claim 11, further including determining a likelihood of a roll over of the tandem arrangement.

22. A system for maintaining a tandem arrangement of a first autonomous vehicle and a second autonomous vehicle, the method comprising:
means for measuring at least one angle, said at least one angle characterizing an orientation of the first autonomous vehicle relative to the second autonomous vehicle;
means for measuring a force between the first autonomous vehicle and the second autonomous vehicle;
means for determining a propulsion, a braking, and a steering of the second autonomous vehicle on the basis of said at least one measured angle and said measured force, said propulsion, said braking, and said steering consistent with maintenance of the tandem arrangement; and
means for effecting said propulsion, said braking, and said steering of the second autonomous vehicle so as to maintain the tandem arrangement of the first autonomous vehicle and the second autonomous vehicle.

23. The system of claim 22, further including means for transmitting said at least one measured angle.

24. The system of claim 22, further including means for transmitting said measured force.

25-27. (canceled)
